(19) United States
(12) Patent Application Publication
(10) Pub. No.: US 2026/0277293 A1
(43) Pub. Date: Sep. 17, 2026

(54) Method and System of Optimizing Processor Power Control Using Utilization Scaling

(71) Applicant: MEDIATEK INC., Hsinchu City (TW)

(72) Inventors: Ping-Tsang Wu, Hsinchu City (TW); Ting-Han Lin, Hsinchu City (TW); Hung-Hsuan Chi, Hsinchu City (TW); Ya-Chi Liang, Hsinchu City (TW); Shih-Min Cheng, Hsinchu City (TW); Yu-Chang Huang, Hsinchu City (TW); Yan-Shao Liu, Hsinchu City (TW); Chi-Cheng Ju, Hsinchu City (TW)

(73) Assignee: MEDIATEK INC., Hsinchu City (TW)

(21) Appl. No.: 19/078,296

(22) Filed: Mar. 13, 2025

(51) Int. Cl. G06F 1/3228; G06F 11/34

(52) U.S. Cl. CPC G06F 1/3228; G06F 11/3409

(57) ABSTRACT

A method of controlling power consumption of a processor in a processing system includes monitoring performance data and system information of the processing system, determining a utilization scaling based on a current state and the performance data of the processing system, and applying the utilization scaling to control a frequency of the processor in the processing system. The method delivers optimal processor power consumption while preserving required performance levels through its adaptive approach. Rather than using static power management techniques, this method continuously monitors system behavior and adjusts processor utilization dynamically.

### BACKGROUND

In embedded systems, CPU power consumption represents a significant portion of overall power usage, making effective power management crucial for device efficiency. This is particularly challenging in modern devices with complex software pipelines, such as smartphone camera applications. These applications must maintain strict performance requirements while minimizing power consumption.

Existing approaches to address this challenge include setting absolute CPU frequency limits or using native Utilization Clamping (Uclamp) feature in Linux. However, frequency capping can compromise performance when tasks require higher processing power, and Uclamp becomes impractical to manage in scenarios with high software complexity. Additionally, these methods often require significant engineering effort to balance power savings with performance requirements.

Therefore, there exists a need for an improved method of controlling processor power consumption that can maintain performance requirements while maximizing power efficiency, particularly in complex pipeline scenarios with strict timing requirements.

An embodiment provides a method of controlling power consumption of a processor in a processing system. The method comprises monitoring performance data and system information of the processing system, determining a utilization scaling based on a current state and the performance data of the processing system, and applying the utilization scaling to control a frequency of the processor in the processing system.

An embodiment provides a processing system. The processing system comprises one or more processors configured to monitor performance data and system information of the processing system, determine a utilization scaling based on a current state and the performance data of the processing system, and apply the utilization scaling to control a frequency of the processor in the processing system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exemplary processing system according to the embodiments.

FIG. 2 illustrates the internal structure of Energy-Aware Scheduling according to the embodiments

FIG. 3 illustrates a flowchart describing a method for controlling power consumption of a processor in the processing system of FIG. 1.

FIG. 4 illustrates a flowchart describing a method of the adaptive control mechanism for managing processor power consumption through utilization scaling.

FIG. 5 illustrates an exemplary processing system according to the embodiments

FIG. 6 illustrates an exemplary hardware block diagram of a processing system 600 according to the embodiments.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

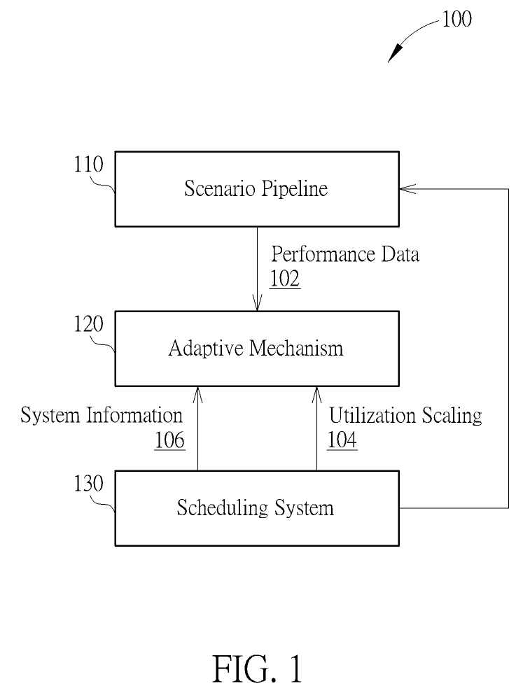

FIG. 1 illustrates a processing system 100 according to the embodiments. The processing system 100 includes a scenario pipeline 110, an adaptive mechanism 120, and a scheduling system 130. The scenario pipeline 110 generates performance data 102, which includes metrics such as latency and jitter. This performance data 102 is provided to the adaptive mechanism 120. Additionally, system information 106, which includes central processing unit (CPU) idle time, Million Cycles Per Second (MCPS), and Million Instructions Per Second (MIPS), is input to the adaptive mechanism 120.

The adaptive mechanism 120 processes both the performance data 102 and system information 106 to determine a utilization scaling 104. This utilization scaling 104 is then provided to the scheduling system 130, which uses it to indirectly influence CPU frequency adjustments. The entire system operates in a closed loop, with the scheduling system 130 feeding back to the scenario pipeline 110.

The adaptive mechanism 120 is designed to maintain performance specifications set by the scenario owner while minimizing CPU power consumption. It achieves this by adjusting the utilization scaling 104 to keep the CPU frequency as low as possible while still meeting the required performance specifications.

This processing system 100 can continually monitor pipeline performance metrics (e.g., latency and jitter) along with system information (such as CPU idle time, MCPS, and MIPS) to dynamically determine the appropriate utilization scaling that influences EAS frequency adjustments, ultimately optimizing CPU power consumption while maintaining required performance levels.

To look more closely, the processing system 100 may represents integrated solution for power management that bridges the gap between high-level application requirements and low-level CPU frequency control. At the top level, the scenario pipeline 110 may represents complex workloads like mobile device camera applications, where multiple threads and processes can be coordinated while meeting strict timing requirements.

The performance data 102 provides crucial real-time metrics about the behavior of the scenario pipeline 110. Beyond just latency and jitter measurements, the performance data 102 may include frame processing times, buffer utilization rates, and other scenario-specific performance indicators that help gauge whether the system is meeting its operational requirements. This comprehensive performance monitoring enables the system to detect both gradual performance degradation and sudden changes that might require immediate response.

The adaptive mechanism 120 serves as the intelligent control center of the system. It can employ sophisticated algorithms to correlate performance data 102 with system information 106, generating a holistic view of the current state of the system. This adaptive mechanism 120 can differentiate between transient spikes in resource demand and sustained changes in workload patterns, allowing it to make informed decisions about resource allocation. The system information 106 provides low-level metrics that help contextualize the performance data, including not just CPU idle time and processing metrics (e.g., CPU idle time, MCPS, and MIPS), but also thermal conditions and resource utilization patterns.

The utilization scaling 104 represents a novel approach to power management. Rather than directly manipulating CPU frequencies, this utilization scaling 104 provides a way to influence frequency selection. This indirect approach preserves the ability of EAS to respond to changing conditions while avoiding disruption in the built-in optimization capabilities of the scheduling system 130. This indirect control method helps maintain system stability while achieving power optimization goals.

The scheduling system 130 makes final decisions on CPU frequency with additional context such as utilization scaling 104. This arrangement preserves the sophisticated power management capabilities while adding an application-aware layer of control that helps balance performance requirements with power efficiency goals. The closed-loop nature of the processing system 100 ensures continuous adjustment and optimization, making it particularly effective for scenarios with varying performance demands and power constraints.

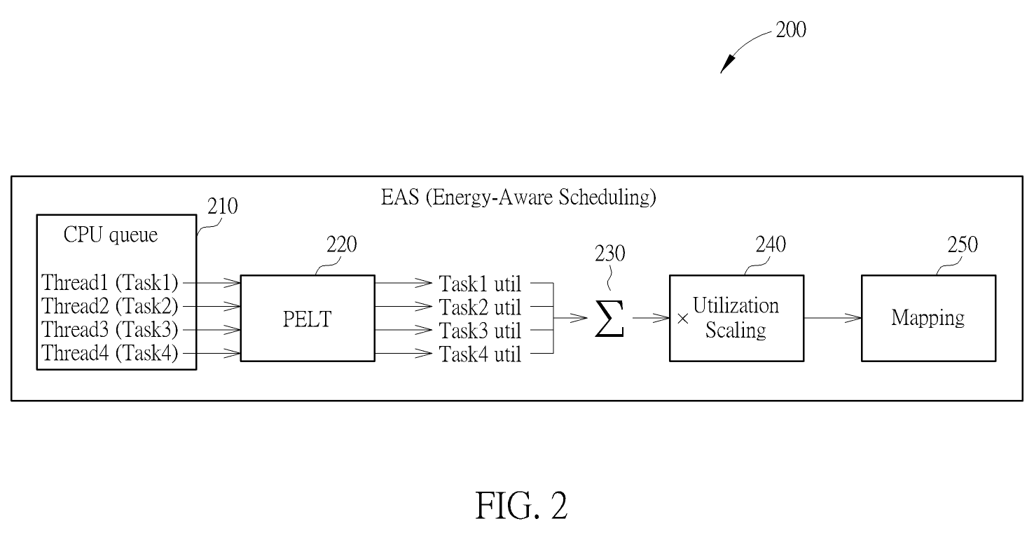

FIG. 2 illustrates the internal structure of the Energy-Aware Scheduling (EAS) 200 according to the embodiments, showing how CPU utilization is processed and scaled to determine processor frequency. The EAS 200 can represent an example of the scheduling system 130 in FIG. 1. The Energy-Aware Scheduling (EAS) system 200 represents an advanced approach to power management that intelligently balances processing requirements with energy efficiency. Unlike simpler frequency scaling mechanisms, it takes into account both individual task characteristics and overall system demands.

The CPU queue 210 includes multiple threads (Thread 1 through Thread 4), each associated with a specific task (Task 1 through Task 4). These represent the active processing tasks waiting to be executed by the system. The CPU queue 210 serves as the entry point for task scheduling. In a real-world scenario, such as a mobile device camera application, these threads might represent various processing stages like image capture, preprocessing, encoding, and post-processing. Each thread carries its own priority and processing requirements.

In one embodiment, a PELT (Per-Entity Load Tracking) block 220 may be included to monitor and calculate the utilization of each task individually. Its function is to estimate CPU utilization for each task, tracking their processing load over time. The output of PELT is individual task utilization values (Task 1 util through Task 4 util). The PELT block 220 implements a sophisticated algorithm that tracks processing load at a granular level. Rather than just measuring instantaneous CPU usage, PELT maintains a weighted history of each task's resource utilization, allowing it to better predict future processing needs. This historical tracking helps prevent rapid oscillations in resource allocation that could impact system stability and energy efficiency.

Per-Entity Load Tracking (PELT) may be represented by a fundamental component of scheduler implementation in Linux, specifically designed to provide accurate task load tracking for scheduling decisions. Within the Linux kernel, PELT can maintain an exponentially weighted moving average of each task's demand on the CPU, updating these measurements at every scheduler tick and task switch event. This tracking mechanism can operate by accumulating the running time of each task and applying an exponential decay to past contributions, effectively giving more weight to recent CPU usage patterns while still maintaining historical context. The Linux implementation of PELT can utilize a 32-bit fixed-point numerical representation to track task utilization, where the maximum value (LOAD_SCALE) can represent one CPU worth of capacity. This fixed-point arithmetic can ensure efficient calculations while maintaining sufficient precision for scheduling decisions. The decay of past utilization can follow a half-life of approximately 32 milliseconds, chosen to provide a balance between responsiveness to load changes and stability in load measurements. At each update interval, PELT can apply this decay function to the existing utilization value and add any new utilization accumulated since the last update. The integration of PELT within the Linux scheduler can enable sophisticated power management decisions by providing detailed insights into individual task behaviors. The scheduler can examine both the instantaneous and historical CPU demands of each task, allowing for more informed decisions about task placement and CPU frequency selection. This granular tracking can become particularly valuable in heterogeneous computing environments, where tasks can be matched with appropriate CPU cores based on their computational demands. The per-entity nature of measurements of PELT can allow the scheduler to distinguish between scenarios where multiple low-demand tasks are running concurrently versus cases where a single high-demand task dominates CPU usage, enabling more precise power optimization strategies.

A characteristic of PELT in Linux can be its ability to handle task migrations between CPU cores while maintaining consistent load tracking. When a task moves from one CPU to another, its load history can follow it, ensuring that scheduling decisions on the new CPU can immediately take into account historical behavior of the task. This migration-aware design can prove especially important in modern mobile devices, where workloads frequently move between cores of different performance and power characteristics, requiring accurate load history for optimal placement decisions. The implementation within Linux can also account for various task states beyond simple running and sleeping. PELT can track different types of sleep states, applying different decay rates depending on whether a task is in interruptible sleep, uninterruptible sleep, or other states. This state-aware tracking can help the scheduler better predict future CPU demands when tasks become runnable again, contributing to more effective power management decisions. The granularity of PELT measurements can enable the system to detect subtle patterns in task behavior, such as periodic bursts of activity or gradual changes in computational demands, which can be leveraged for proactive power optimization strategies.

The summation block 230 (Σ) can combine the individual task utilization values from PELT into a single aggregate utilization metric, which represents the total processing demand from all active tasks. This aggregation accounts for various factors such as task priorities, dependencies, and timing requirements. The summation process helps provide a comprehensive view of the system's processing needs at any given moment.

The utilization scaling block 240 can multiply the utilization scaling to the summed utilization value. This scaling operation is crucial for power management as it allows the system to adjust the perceived processing demand before it is used to determine CPU frequency. The utilization scaling block 240 represents the core contribution to power management. By adjusting the perceived utilization through scaling, it creates a buffer between raw processing demands and actual CPU frequency selection. This scaling can be dynamically adjusted based on higher-level performance metrics, allowing the system to optimize power consumption while maintaining required performance levels.

The mapping block 250 converts the scaled utilization value into an appropriate CPU frequency, such that the CPU frequency can be controlled based on the scaled utilization value. This block determines the actual operating frequency of the processor based on the adjusted utilization value. The mapping block 250 applies the final translation from scaled utilization values to actual CPU frequency. The mapping block 250 may consider various hardware constraints, such as available frequency steps, thermal limitations, and power consumption characteristics of the processor. This would ensure that the theoretical demands calculated by the system (e.g., processing system 100) are translated into practical, achievable frequency settings.

In certain embodiments, Window Assisted Load Tracking (WALT) may be included (instead of or in addition to PELT within the scheduling system). While PELT tracks CPU utilization at the individual task level, WALT evaluates CPU utilization over specified time windows (e.g., 16ms intervals), potentially encompassing multiple tasks. When WALT is implemented, the utilization scaling can be applied directly to window-based utilization output, rather than to the sum of individual task utilizations as in the PELT implementation. This alternative implementation maintains the core functionality of the power management approach in this specification, as the utilization scaling still serves to influence CPU frequency selection based on system performance requirements and current operating conditions. The key distinction lies in how the base utilization is calculated: rather than tracking and summing individual task loads, WALT provides an aggregate utilization measure for the specified time window, which is then scaled according to the determined utilization scaling factor. This implementation flexibility allows the system to adapt to different scheduling architectures while preserving the fundamental benefits of the utilization scaling mechanism for power optimization.

WALT can be represented by an alternative approach to CPU load measurement within the Linux scheduler, designed to provide window-based task tracking for scheduling decisions. Within the Linux kernel, WALT can maintain utilization metrics over fixed time windows, typically spanning 16-20 milliseconds, which can align naturally with frame-based application requirements common in mobile devices. This tracking mechanism can operate by aggregating CPU utilization across all tasks within each time window, providing a comprehensive view of system load that can be particularly effective for real-time workload management. The Linux implementation of WALT can utilize a window-based numerical representation to track system utilization, where measurements can be reset at window boundaries to ensure accurate tracking of current system demands. This windowed approach can provide efficient calculations while maintaining precise timing alignment with typical application workflows. The measurement of utilization can be based on actual running time within each window, which can offer more direct correlation with real-world task behaviors. At each window boundary, WALT can reset its accumulation counters, ensuring that new measurements can accurately reflect current system conditions without being influenced by distant historical patterns. The integration of WALT within the Linux scheduler can enable responsive power management decisions by providing temporally relevant insights into system behavior. The scheduler can examine both utilization of the current window and recent window history, allowing for more contextual decisions about CPU frequency selection. This window-based tracking can become particularly valuable in mobile computing environments, where rapid response to load changes can be essential for maintaining user experience while optimizing power consumption. The aggregate nature of WALT measurements can allow the scheduler to respond effectively to sudden changes in system load, as each new window can provide a fresh perspective on current processing demands.

A characteristic of WALT in Linux can be its ability to handle a workload burst effectively. The window-based measurement approach can ensure that brief periods of high activity can be accurately captured without being averaged out over longer periods. This design choice can prove especially important in interactive systems, where rapid response to user input can be critical, and the ability to quickly detect and respond to load changes can significantly impact both performance and power efficiency. The implementation within Linux can also account for various system-level activities beyond simple task execution time. WALT can track context switch overheads, interrupt handling time, and other system events within each window, providing a more complete picture of system utilization. This comprehensive tracking can help the scheduler make more informed decisions about power management, as it can consider all factors contributing to CPU load. The temporal granularity of WALT measurements can enable the system to maintain responsive behavior while still providing stable utilization metrics for power management decisions, which can be essential for balancing performance requirements with power efficiency goals.

These components, as described in FIG. 2 and the associated paragraphs, collectively represent an improved sophisticated control system that can adapt to varying workload conditions while maintaining optimal power efficiency. The ability of the system to scale utilization before frequency mapping provides a powerful tool for fine-tuning the balance between performance and power consumption.

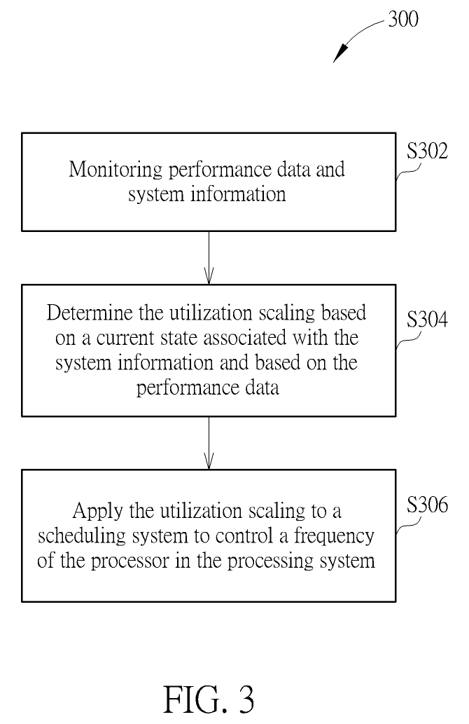

FIG. 3 illustrates a flowchart describing a method 300 for controlling power consumption of a processor in the processing system 100. The method 300 includes the following steps:

S302: Monitoring performance data 102 and system information 106;

S304: Determine the utilization scaling 104 based on a current state associated with the system information 106 and based on the performance data 102; and

S306: Apply the utilization scaling 104 (for example, to the scheduling system 130).

It should be noted that the performance data 102 is associated with the scenario pipeline (e.g., latency and jitter). System information 106 provides low-level operational data including CPU idle time, MCPS, and MIPS.

The initial step S302 involves concurrent tracking of two distinct data streams. Firstly, performance data 102 provides critical metrics from the scenario pipeline, specifically focusing on latency and jitter measurements. These metrics serve as key indicators of whether the system is meeting its performance requirements. For example, in a camera application, this might include frame processing times and display latency. Secondly, system information 106 encompasses various low-level metrics such as CPU idle time, MCPS (Million Cycles Per Second), and MIPS (Million Instructions Per Second). This information provides crucial context about current operating state and resource utilization of the system.

The system performs a complex analysis to determine the appropriate utilization scaling 104. This determination considers current state of the processing system 100 and performance data 102. The processing system 100 evaluates whether it is in a steady state or transient state based on the system information 106. This helps distinguish between temporary spikes in demand and sustained changes in processing requirements. Also, it analyzes whether current performance metrics meet specified requirements and how much headroom exists for power optimization.

The step S306 involves applying the calculated utilization scaling 104 to the scheduling system 130 (e.g., EAS). This implementation can influence CPU frequency selection indirectly through the native mechanisms of the EAS, preserve its ability to respond to dynamic system conditions, maintain system stability while achieving power optimization, and allow for continuous adjustment as new monitoring data becomes available.

The entire process operates in a closed-loop, with continuous monitoring and adjustment ensuring optimal power efficiency while maintaining required performance levels.

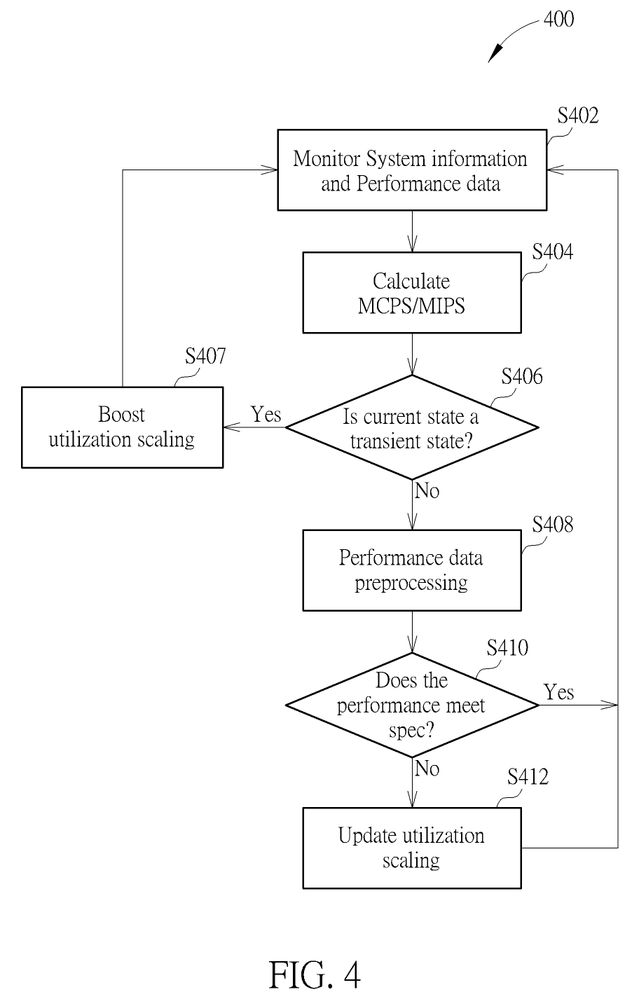

FIG. 4 illustrates a flowchart describing a method 400 of the adaptive control mechanism for managing processor power consumption through utilization scaling. The method 400 includes the following steps:

S402: Monitor system information 106 and performance data 102;

S404: Calculate MCPS and/or MIPS;

S406: Determine whether the current state is a transient state; if so, proceed to step S407; if not, proceed to step S408;

S407: Boost utilization scaling 104, and go back to step S402;

S408: Preprocess performance data 102;

S410: Determine whether the performance meet the specification of the processing system 100; if so, go back to step S402; if not, proceed to step S412;

S412: Update the utilization scaling 104, and go back to step S402.

In step S402, this initial stage involves comprehensive data collection from multiple system sources. The monitoring system simultaneously tracks performance data 102 from the scenario pipeline 110, such as latency and jitter measurements, while also gathering system information 106 including CPU idle time, resource utilization, and operational metrics. This dual monitoring approach ensures that both high-level performance requirements and low-level system conditions are considered in the decision-making process.

In this computational step S404, the system processes the raw monitoring data to calculate two crucial performance metrics: Million Cycles Per Second (MCPS) and Million Instructions Per Second (MIPS). These calculations provide quantitative measures of the processing activity and efficiency of the system. The MCPS metric indicates raw processing throughput, while MIPS provides insight into actual instruction execution rates, together offering a comprehensive view of processing efficiency.

At the decision step S406, the adaptive mechanism 102 evaluates whether current conditions represent a transient state requiring immediate response. This determination is based on analyzing sudden changes in system metrics and performance indicators.

When a transient state is detected at step S407, the processing system 100 implements an immediate boost to the utilization scaling 104. This rapid response helps ensure system responsiveness during sudden workload increases or performance demands, temporarily prioritizing performance over power efficiency to maintain system stability and user experience.

For non-transient states, step S408 involves preparing and filtering (e.g., by Kalman filter) the collected performance data 102 for analysis. The preprocessing may include noise reduction, trend analysis, and data normalization to ensure accurate performance evaluation. This refined data provides a clearer picture of system performance trends and requirements.

At another decision step S410, the current system performance is compared against predefined specifications. The evaluation considers multiple performance metrics simultaneously, including latency targets, throughput requirements, and other scenario-specific criteria. This comprehensive evaluation ensures that all performance requirements are being met.

At step S412, when performance data does not meet specifications (either fall behind or exceed the specification), the processing system 100 calculates and implements a new utilization scaling. The update process considers both the magnitude of performance deviation and historical scaling effectiveness. The adjustment aims to bring performance metrics back within specified ranges while maintaining optimal power efficiency. In another words, if the performance exceeds the specification, the utilization scaling can be decreased to bring the performance back to the specification for power efficiency. If the performance falls behind the specification, the utilization scaling can be increased to boost the performance to meet the specification for system stability and user experience.

The continuous loop structure of this process ensures constant adaptation to changing conditions, with each cycle refining the balance between performance and power consumption. This adaptive approach allows the processing system 100 to maintain optimal performance while minimizing power consumption across varying workload conditions and user scenarios. This sophisticated control mechanism demonstrates how the processing system 100 can maintain performance requirements while optimizing power consumption through careful monitoring, analysis, and dynamic adjustment of the utilization scaling. The process combines immediate response capabilities for transient conditions with thoughtful adjustment for steady-state operation, ensuring both responsiveness and efficiency.

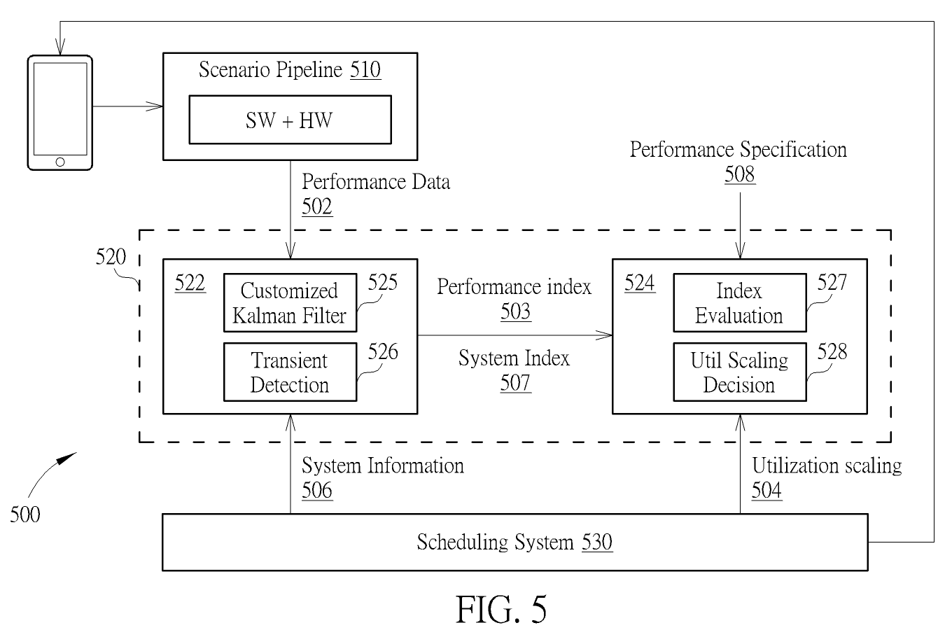

FIG. 5 illustrates an exemplary processing system 500 according to the embodiments, implemented in a mobile device (e.g., smartphone) for sophisticated management of processor resources. The scenario pipeline 510 may represent complex applications like mobile device camera systems that combine both software and hardware processing elements (SW+HW). Performance data 502 can be obtained from the scenario pipeline 510. The performance data 502 carries crucial metrics about system behavior such as latency and jitter measurements. These metrics provide essential feedback about the real-time performance of the application.

Two main processing blocks form the core of the adaptive mechanism 520. Block 522 includes a customized Kalman filter 525 for processing performance data and a transient detection module 526 for identifying temporary state changes. Block 524 includes index evaluation function 527 and utilization scaling decision function 528. The adaptive mechanism 520 processes two primary inputs: performance data 502 from the scenario pipeline and system information 506 (e.g., MCPS, MIPS) from other components. It generates both a performance index 503 and system index 507, which feed into the block 524 for determining utilization scaling 504 according to performance specification 508. In other words, the block 524 determines the utilization scaling 504 based on performance index 503, system index 507, and performance specification 508.

The scheduling system 530 receives the utilization scaling 504 and applies it to manage processor frequency. This creates a closed-loop system where the scheduling decisions influence the performance of the scenario pipeline, which in turn affects future scaling decisions.

The customized Kalman filter 525 can process raw performance data from the scenario pipeline, particularly latency and jitter measurements. This processing produces more stable and dependable metrics for power management decisions. The customized Kalman filter 525 operates through a continuous prediction-correction cycle, where it maintains an ongoing estimate of the system performance state while accounting for both measurement noise and inherent system dynamics. This is particularly crucial in complex scenarios like mobile device camera applications, where multiple threads and processing stages can create noisy performance measurements. In addition, the customized Kalman filter 525 can combine predictions with actual measurements, while weighting them based on their reliability, helps prevent the system from overreacting to temporary fluctuations that could lead to unnecessary frequency adjustments. Through this sophisticated filtering approach, the processing system 500 can maintain more stable power management behavior while still responding appropriately to genuine changes in performance requirements. The filtered data provides a more reliable basis for utilization scaling decisions, helping the system achieve its dual goals of maintaining performance specifications while optimizing power consumption.

It should be emphasized that while the described implementation utilizes a customized Kalman filter, this represents just one possible approach to processing performance data. The core innovation of this invention lies in its adaptive mechanism for power management, which could potentially employ various other filtering or signal processing techniques. The selection of an appropriate filtering method may depend on specific system requirements, computational resources, and performance characteristics of the target application.

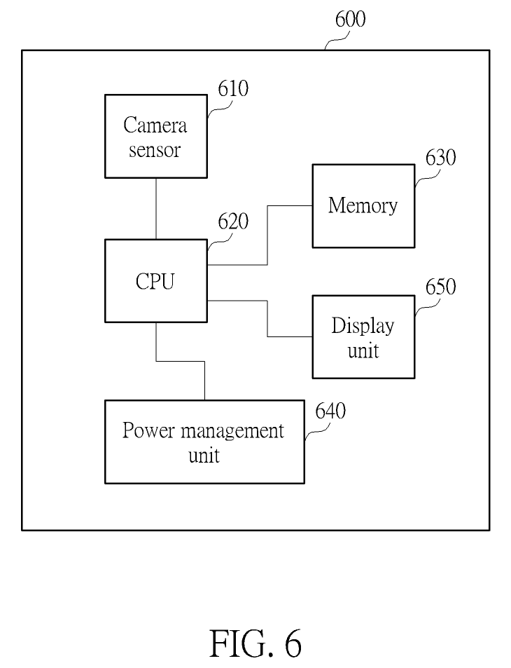

FIG. 6 illustrates an exemplary hardware block diagram of a processing system 600 according to the embodiments. The processing system 600 includes a camera sensor 610, a central processing unit (CPU) 620, a memory 630, a power management unit 640, and a display unit 650.

The camera sensor 610 is coupled to the CPU 620, enabling the transmission of image data from the sensor to the processor. The CPU 620 is further coupled to the memory 630, facilitating data storage and retrieval operations essential for image processing tasks. The CPU 620 can be implemented using various processor architectures including, but not limited to, ARM, x86, RISC-V, MIPS, PowerPC, SPARC, or any other suitable processor architecture capable of performing the computational tasks described herein.

The power management unit 640 is coupled to the CPU 620 or is part of function block executed by the CPU 620 and is used to control the power consumption of the processor. This unit implements the power management functions, including frequency scaling operations based on the utilization scaling determined by the adaptive mechanism described in the invention. The power management unit 640 can be implemented with specialized hardware circuitry designed to efficiently manage processor power consumption through the utilization scaling mechanism. The power management unit 640 includes frequency control interfaces comprising hardware registers configured to control CPU frequency scaling, interfaces with CPU voltage regulators for dynamic voltage scaling, and clock generation and distribution circuits. These components work in concert to support multiple frequency operating points, enabling fine-grained control over processor power states.

To facilitate accurate power management decisions, the power management unit 640 may incorporate state monitoring hardware including performance counters for tracking MCPS and MIPS metrics, CPU utilization monitors, and integrated temperature sensors. These monitoring components provide real-time feedback about system operation, enabling the power management unit to maintain optimal performance while minimizing power consumption. The unit also interfaces directly with CPU idle state management systems to coordinate power-saving states across the processing system.

The control logic within the power management unit 640 implements sophisticated state machines for managing frequency transitions, voltage scaling coordination logic, and safety monitoring systems for frequency and voltage transitions. This control logic ensures proper clock domain crossing management and handles interrupts related to utilization scaling updates. The implementation may include dedicated hardware accelerators for PELT calculations, enabling efficient processing of task utilization data and rapid response to changing system conditions.

Integration with system software can be achieved through memory-mapped registers that provide software control interfaces. The power management unit 640 supports both polling and interrupt-based update mechanisms, allowing flexible implementation of power management policies. Configuration registers store performance thresholds and other parameters that guide the power management decisions, enabling dynamic adjustment of power management behavior based on system requirements.

Furthermore, the power management unit 640 may incorporate power state management capabilities, including support for multiple power domains, power gating control, and clock gating logic. The power management unit 640 manages retention states and wake-up control logic to minimize power consumption during idle periods while ensuring rapid response to processing demands. When receiving utilization scaling values from the CPU 620, the power management unit 640 translates these into appropriate frequency and voltage settings while maintaining safe operating conditions and coordinating voltage transitions with frequency changes.

Finally, thermal management can be integrated into the power management unit 640 with dedicated circuitry monitoring and responding to temperature conditions. This ensures that power management decisions take into account thermal constraints, preventing potential thermal issues while maintaining optimal performance.

The display unit 650 can be coupled to the CPU 620 and is used for presenting pictures captured by the camera sensor 610. The display unit 650 can be selected based on specific application requirements and may include, but not limited to, liquid crystal displays (LCD), organic light-emitting diode (OLED) displays, or any other suitable display technology.

This hardware architecture enables the implementation of the power optimization method, where the CPU 620 executes the scenario pipeline and adaptive mechanism while the power management unit 640 applies the determined utilization scaling to control processor frequency and power consumption. The memory 630 stores program instructions and data required for these operations, including performance metrics and system information used in the adaptive power management process.

The various embodiments of the above described invention offer several significant advantages in the field of power management for embedded systems. The primary benefit lies in its ability to achieve optimal processor power consumption while maintaining required performance levels through an innovative adaptive approach. The use of utilization scaling as an indirect control mechanism represents a major improvement over traditional methods. Unlike direct frequency capping, which can compromise system responsiveness, this approach can preserve the native ability of the EAS to respond to changing workload conditions. This results in more nuanced and effective power management, particularly in complex scenarios like smartphone camera applications.

Another key advantage is the ability to adapt to different performance requirements across various scenarios. By continuously monitoring both performance metrics and system information, the system can dynamically adjust power consumption based on actual needs rather than static configurations. This adaptive capability eliminates the need for manual tuning of frequency settings for different use cases, reducing development effort and improving system reliability.

Finally, the closed-loop design ensures continuous optimization and stable operation. By monitoring performance metrics and adjusting the utilization scaling accordingly, the system can maintain optimal power efficiency while preventing performance degradation. This self-correcting mechanism makes the system more robust and reliable in real-world applications.

The terminology employed in the description of the various embodiments herein is intended for the purpose of describing particular embodiments and should not be construed as limiting. In the context of this description and the appended claims, the singular forms "a", "an", and "the" are intended to encompass plural forms as well, unless the context clearly indicates otherwise.

It should be understood that the term "and/or" as used herein is intended to encompass any and all possible combinations of one or more of the associated listed items. Furthermore, it should be noted that the terms "includes," "including," "comprises," and/or "comprising," when used in this specification, indicate the presence of stated features, integers, steps, operations, elements, and/or components, but do not exclude the presence or addition of one or more other features, integers, steps, operations, elements, components, and/or groups thereof.

Unless specifically stated otherwise, the term "some" refers to one or more. Various combinations using "at least one of" or "one or more of" followed by a list (e.g., A, B, or C) should be interpreted to include any combination of the listed items, including individual items and multiple items.

Terms such as "coupled," "connected," "connecting," and "electrically connected" are used synonymously to describe a state of being linked together through physical wires or wireless connections to enable electrical or electronic communications. When an entity is described as being in "communication" with another entity or entities, it implies the capability of sending and/or receiving electrical signals, which may contain data/control information, regardless of whether these signals are analog or digital in nature.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a graphics processing unit (GPU), a tensor processing unit (TPU), a neural network processing unit (NPU), a digital signal processor (DSP), an application specific integrated circuit (ASIC), a field programmable gate array (FPGA), other programmable logic devices (PLDs), discrete gate or transistor logic, discrete hardware components, any suitable combination thereof. Such hardware and apparatus shall be configured to perform the functions described herein.

A general-purpose processor may include, but is not limited to, a central processing unit (CPU), a microprocessor, or alternatively, any conventional processor, controller, microcontroller or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling power consumption of a processor in a processing system, comprising:
monitoring performance data of the processing system and system information of the processing system;
determining a utilization scaling based on a current state associated with the system information and based on the performance data of the processing system; and
applying the utilization scaling to control a frequency of the processor in the processing system.

2. The method of claim 1, wherein determining the utilization scaling comprises:
determining the current state is a transient state based on the system information; wherein the transient state comprises an abrupt increase in a Million Cycles Per Second (MCPS) and/or a Million Instructions Per Second (MIPS) of the processing system; and
boosting the utilization scaling.

3. The method of claim 1, wherein determining the utilization scaling comprises:
determining the current state is not a transient state based on the system information, wherein the transient state comprises an abrupt increase in a MCPS and/or a MIPS of the processing system; and
preprocessing the performance data.

4. The method of claim 3, wherein determining the utilization scaling further comprises:
if the preprocessed performance data falls below a predetermined threshold, increasing the utilization scaling.

5. The method of claim 3, wherein determining the utilization scaling comprises:
if the preprocessed performance data exceeds a predetermined threshold, decreasing the utilization scaling.

6. The method of claim 1, wherein applying the utilization scaling comprises:
tracking per-entity load for each task of a plurality of tasks in a queue of the processor; and
determining a utilization value for the each task according to the per-entity load of each task.

7. The method of claim 6, wherein applying the utilization scaling further comprises:
summing the utilization value for the each task of the plurality of tasks to obtain a total utilization value; and
multiplying the total utilization value by the utilization scaling to obtain a scaled utilization value, wherein the frequency of the processor is controlled based on the scaled utilization value.

8. The method of claim 1, wherein applying the utilization scaling comprises:
tracking CPU utilization within a predetermined time window for a plurality of tasks in a queue of the processor; and
determining an aggregate utilization value for the predetermined time window according to a total CPU utilization of the plurality of tasks within the predetermined time window.

9. The method of claim 1, wherein the performance data comprise at least one of:
a latency between an image sensor capture and a display output; and
a jitter across a plurality of concurrent threads associated with the processor.

10. The method of claim 1, wherein the system information comprises at least one of: an idle time of the processor, a MCPS of the processor and a MIPS of the processor.

11. The method of claim 1, wherein the processing system comprises a Linux based processing system or Energy Aware Scheduling (EAS).

12. A processing system comprising one or more processors configured to:
monitor performance data and system information of the processing system;
determine a utilization scaling based on a current state and the performance data of the processing system; and
apply the utilization scaling to control a frequency of the processor in the processing system.

13. The processing system of claim 12, wherein the one or more processors are further configured to:
determine the current state is a transient state based on the system information; wherein the transient state comprises an abrupt increase in a Million Cycles Per Second (MCPS) and/or a Million Instructions Per Second (MIPS) of the processing system; and
boost the utilization scaling.

14. The processing system of claim 12, wherein the one or more processors are further configured to:
determine the current state is not a transient state based on the system information, wherein the transient state comprises an abrupt increase in a MCPS and/or a MIPS of the processing system; and
preprocess the performance data.

15. The processing system of claim 14, wherein the one or more processors are further configured to:
if the preprocessed performance data falls below a predetermined threshold, increase the utilization scaling.

16. The processing system of claim 14, wherein the one or more processors are further configured to:
if the preprocessed performance data exceeds a predetermined threshold, decrease the utilization scaling.

17. The processing system of claim 12, wherein the one or more processors are further configured to:
track per-entity load for each task of a plurality of tasks in a queue of the processor; and
determine a utilization value for the each task according to the per-entity load of each task.

18. The processing system of claim 17, wherein the one or more processors are further configured to:
sum the utilization value for the each task of the plurality of tasks to obtain a total utilization value; and
multiply the total utilization value by the utilization scaling to obtain a scaled utilization value, wherein the frequency of the processor is controlled based on the scaled utilization value.

19. The processing system of claim 12, wherein the one or more processors are further configured to:
track CPU utilization within a predetermined time window for a plurality of tasks in a queue of the processor; and
determine an aggregate utilization value for the predetermined time window according to a total CPU utilization of the plurality of tasks within the predetermined time window.

20. The processing system of claim 12, wherein the performance data comprise at least one of:
a latency between an image sensor capture and a display output; and
a jitter across a plurality of concurrent threads associated with the processor.
